(19) United States
(12) Patent Application Publication
(10) Pub. No.: US 2026/0161791 A1
(43) Pub. Date: Jun. 11, 2026

(54) SCANNING DIGITAL APPLICATIONS TO DETECT ACCESS CONTROL SECURITY RISKS

(71) Applicant: OneTrust LLC, Atlanta, GA (US)

(72) Inventors: Julian Evans, Huntingdon (GB); Alexander John Collins, Bristol (GB)

(21) Appl. No.: 18/970,728

(22) Filed: Dec. 5, 2024

(51) Int. Cl. G06F 21/57

(52) U.S. Cl. CPC G06F 21/577; G06F 2221/034

(57) ABSTRACT

This disclosure describes some aspects of systems, non-transitory computer-readable media, and computer-implemented methods that scan digital applications to intelligently detect potentially insecure data access controls from the digital applications. In particular, the disclosed systems can parse application development libraries to identify potentially insecure data access controls available for utilization within digital applications. Moreover, the disclosed systems can scan an application to detect access controls utilized within the application. Additionally, the disclosed systems can compare the detected, utilized access controls of an application to the potentially insecure data access controls to determine one or more potentially insecure data access controls utilized within the scanned application. In addition, based on detecting one or more potentially insecure data access controls utilized within the scanned application, the disclosed systems can trigger a variety of digital actions within an application scanning platform for the application in response to the one or more potentially insecure data access controls.

### BACKGROUND

Recent years have seen an increasing implementation of computer systems that implement scanning tools to analyze digital application functions. Specifically, many entities increasingly utilize scanning tools to analyze applications to identify data processing activities performed by the applications. Indeed, such scanning tools are often utilized to identify tracking technologies used by websites and applications. For example, application store platforms (e.g., platforms that deploy applications to various users) often utilize scanning tools and/or manual review to identify tracking technologies (or other data processing activities) present in an application prior to distributing the application. While scanning tools exist to analyze an application, existing scanning tools are often limited in insight, often result in convoluted outputs (especially when an application contains a large number of data processing activities), and often result in UIs and outputs that are difficult to navigate.

To illustrate, many systems receive (or analyze) applications that are large in size (e.g., thousands of lines of code, tens of thousands of lines of code, thousands of components, thousands of method calls) and often reference various internal and imported libraries, call functions, data types, and access controls. In many cases, the application codes often also utilize different coding styles, coding languages, syntax, and semantics such that it is difficult to analyze the referenced libraries, call functions, data types, and access controls. Accordingly, many existing scanning tools are only capable of detecting and outputting limited information from applications. Often, existing scanning tools generate simple and unintelligent outputs that simply list components related to the application (e.g., identified libraries, call functions, data type references, access controls).

In addition, due to the size of many applications, many conventional scanning tools result in convoluted output data. For instance, by simply listing various components present within an application that may include a significant number of data processing activities, many existing scanning tools output a substantially large list of components. In addition, existing scanning tools often present components by identifying the access controls utilized by the application (e.g., a specific access control APIs, method calls for access controls, access control functions) in addition to other application data (e.g., SDKs, coding language information, method call data). This often results in a large list (e.g., thousands) of specific references, calls, or access control functions present in the application (in an unedited syntax) that are difficult to comprehend and/or meaningfully utilize.

Moreover, conventional scanning tools are also often difficult (and inefficient) to navigate. Indeed, in many cases, existing scanning tools result in inefficient user interfaces (UIs) that are difficult to navigate. To illustrate, many conventional scanning tools result in a substantially large list of output, detected components (e.g., access control utilization, method calls). In many cases, such large lists of components are inefficiently listed in a UI by conventional application scanners. As such, conventional scanning tools often result in UIs that require many navigational steps to review large lists of components. In addition to not easily presenting the breadth of information detected from large applications (or application codes) within compact UIs, many existing scanning tools also require additional navigation to comprehend the scan results (or listed components). For instance, oftentimes, the existing scanning tool lists components detected within an application and require users to inefficiently navigate between various libraires and/or search engines to determine the listed components (and the components' purpose). In addition, due to the breadth of information detected from large applications and unique data processing activities of each application, many existing scanning tools often fail to identify the significance of a detected component.

In addition to the foregoing, recent surges in data usage have introduced complex challenges for large organizations, particularly concerning data sprawl, which poses significant risks to data security and privacy. Data sprawl, in this context, pertains to the proliferation of independent software applications that handle and store data, including sensitive or personal information. This proliferation makes it challenging to monitor what software applications are tracking what data, the usage of data by software applications, and interactions between the software applications and user devices, thereby elevating the risk of data breaches and security incidents. One contributor to data sprawl is not knowing what data is being tracked or shared in conjunction with interactions between software applications and user devices (via access control permissions of a software application). This is often the result of existing scanning tools providing results that are difficult to comprehend, navigate, and/or meaningfully utilize as described above.

Furthermore, the foregoing problems can be easily exacerbated due to the frequency of software updates. Specifically, frequent software revisioning and updating can lead to changes in data tracking and usage that go undetected. Alternatively, software updates can require re-scanning of a software applications and a substantial number of components corresponding to the software applications.

These and other problems exist with regard to conventional application scanning tools.

### SUMMARY

This disclosure describes on one or more aspects that provide benefits and solve one or more of the foregoing or other problems in the art with systems, non-transitory computer-readable media, and computer-implemented methods that scan digital applications to intelligently detect potentially insecure data access control components from the digital applications. In particular, the disclosed systems can parse application development libraries to identify (and categorize) potentially insecure data access control components (e.g., access control functions that pose a security risk via potentially deprecated functions, potential flaws, or other potential security compromises) available for utilization within digital applications. Moreover, the disclosed systems can scan a digital application to detect access controls (e.g., application permissions) utilized within the digital application. Additionally, the disclosed systems can utilize a potentially insecure data access control detection model to compare the detected, utilized access controls of a digital application to the potentially insecure data access control components (identified by via parsing application development libraries) to determine one or more potentially insecure data access controls utilized within the scanned digital application. In addition, based on detecting one or more potentially insecure data access controls utilized within the scanned digital application, the disclosed systems can trigger a variety of digital actions within an application scanning platform for the digital application in response to the one or more potentially insecure data access controls (e.g., generate scan reports to highlight the security risks, generate data mappings or libraries in connection to the digital application to expose the application security flaws, data privacy compliance automation actions).

### BRIEF DESCRIPTION OF THE DRAWINGS

The detailed description is described with reference to the accompanying drawings in which:

FIG. 1 illustrates an overview of an application scanning service system detecting potentially insecure data access control components in digital applications in accordance with one or more implementations.

FIG. 2 illustrates an application scanning service system determining potentially insecure data access controls from one or more application component libraries in accordance with one or more implementations.

FIG. 3 illustrates an application scanning service system detecting one or more potentially insecure data access controls from a digital application in accordance with one or more implementations.

FIG. 4 illustrates an application scanning service system triggering one or more digital actions based on detected utilized potentially insecure data access controls in accordance with one or more implementations.

FIGS. 5 and 6 illustrate an application scanning service system generating and displaying application scan reports for digital applications based on one or more detected potentially insecure data access controls in accordance with one or more implementations.

FIG. 7 illustrates a schematic diagram of an example environment in which an application scanning service system operates in accordance with one or more implementations.

FIG. 8 illustrates a flowchart of a series of acts for scanning a digital application to determine potentially insecure data access controls for the digital application in accordance with one or more implementations.

FIG. 9 illustrates a block diagram of an example computing device in accordance with one or more implementations.

### DETAILED DESCRIPTION

One or more aspects of the present disclosure include an application scanning service system that scans a digital application to determine potentially insecure data access control components from the digital application (and to trigger digital actions based on the potentially insecure data access control components). For instance, the application scanning service system can identify potentially insecure data access controls from one or more access control libraries available to digital applications (e.g., via parsing). Moreover, the application scanning service system can detect utilized access controls within a scanned digital action. Additionally, the application scanning service system can generate a set of utilized potentially insecure data access controls detected within the digital application utilizing a potentially insecure data access control detection model to determine matches between the utilized access controls (from the digital application) and the potentially insecure data access controls from one or more access control libraries available to digital applications. Additionally, based on the detection of one or more potentially insecure data access controls utilized within the scanned digital application, the disclosed systems can trigger digital actions across a data security platform for the digital application in response to the one or more potentially insecure data access controls predicted to be present in the digital application.

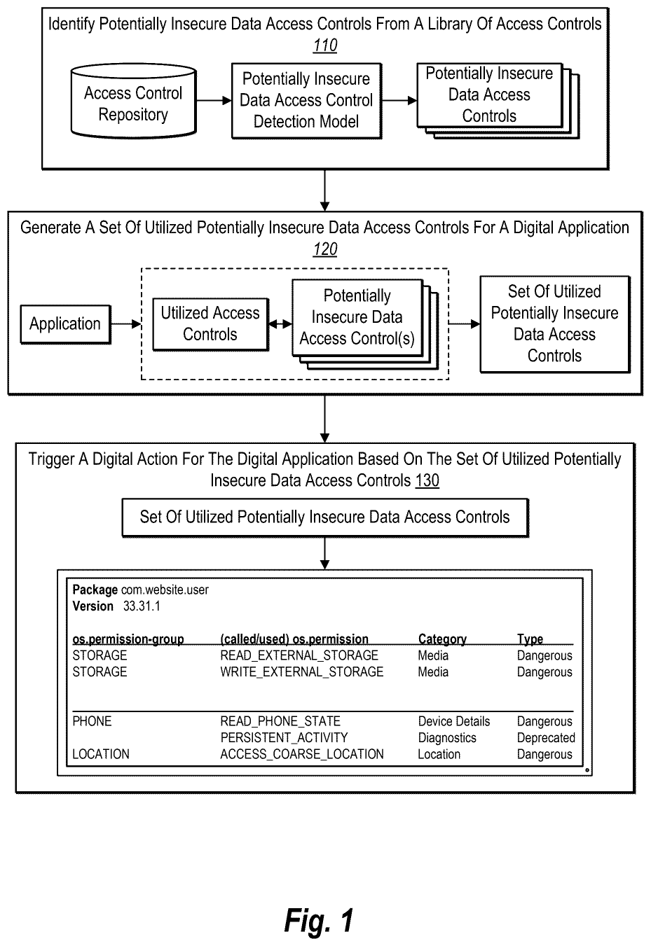

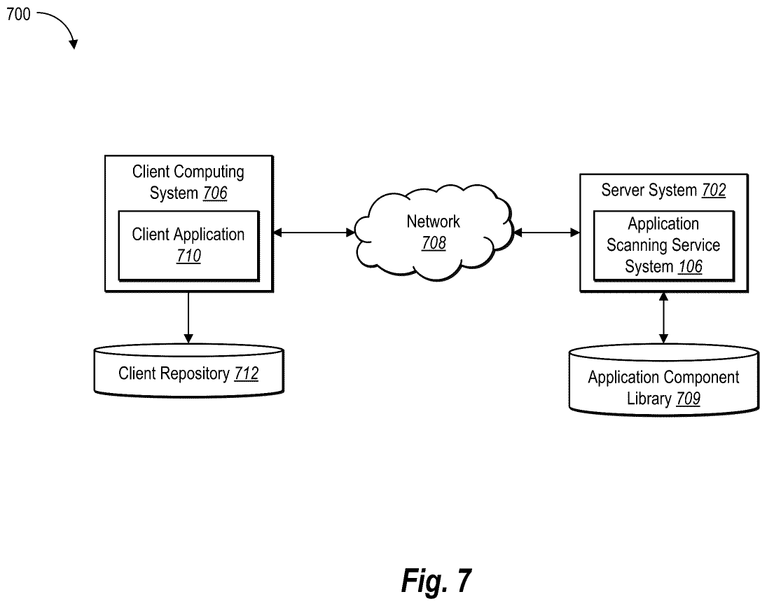

For example, FIG. 1 illustrates an overview of the application scanning service system 106 (e.g., as described in FIG. 7) detecting potentially insecure data access control components in digital applications. In addition, FIG. 1 also illustrates an overview of the application scanning service system 106 utilizing digital actions to react to detected potentially insecure data access control components in digital applications. Indeed, FIG. 1 illustrates the application scanning service system 106 identifying potentially insecure data access controls from a library of access controls, generating a set of utilized potentially insecure data access controls for a digital application, and triggering a digital action for the digital application based on the set of utilized potentially insecure data access controls.

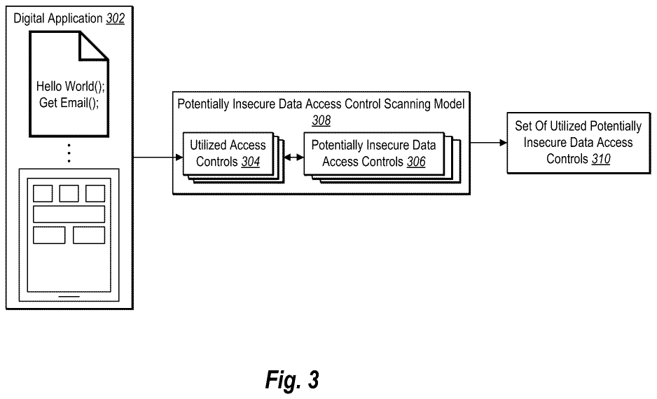

For instance, as shown in an act 110 of FIG. 1, the application scanning service system 106 identifies potentially insecure data access controls from a library of access controls. In one or more instances, the application scanning service system 106 parses data from one or more access control libraries (e.g., an access control repository) available to digital applications to identify access controls for the digital applications. In addition, the application scanning service system 106 can further determine (or detect), from the identified access controls, potentially insecurities (e.g., security risks, flaws, or other security compromises) related to the access controls from data in the one or more access control libraries by utilizing a potentially insecure data access control detection model (as shown in the act 110). In some cases, the application scanning service system 106 also identifies or generates purpose type descriptors for the potentially insecure data access controls to describe an insecurity type. Moreover, in some aspects, the application scanning service system 106 also categorizes the identified potentially insecure data access controls within access control categories (e.g., data type categories) to associate potentially insecurities with particular access control categories. Indeed, the application scanning service system 106 can utilize the identified potential insecurities (and additional details) to generate (or identify) a set (or list) of potentially insecure data access controls useable on (or available to) digital applications. In one or more instances, the application scanning service system 106 identifies potentially insecure data access controls as described in greater detail below (e.g., in reference to FIG. 3).

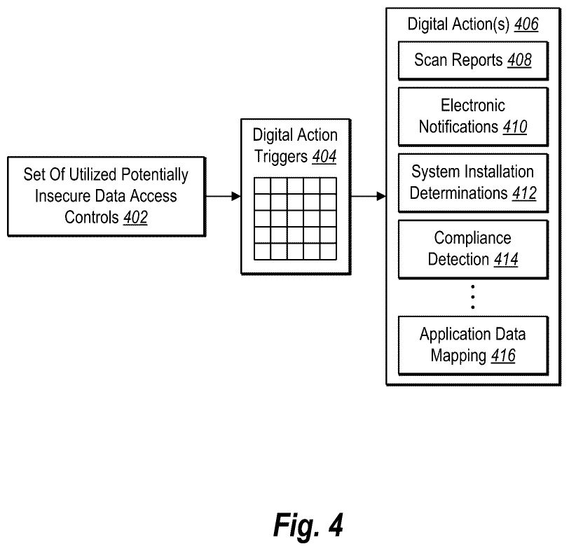

In addition, as shown in an act 120 of FIG. 1, the application scanning service system 106 generates a set of utilized potentially insecure data access controls for a digital application. In particular, the application scanning service system 106 can scan a digital application to identify (or detect) one or more utilized access controls in the digital application (e.g., application permissions that enable a digital application to utilize one or more components of a computing device and/or data of a user on the computing device). For instance, as shown in the act 120, the application scanning service system 106 compares the utilized access controls detected from the digital application to the potentially insecure data access control(s) (from the one or more access control libraries) to determine a set of utilized potentially insecure data access controls. Indeed, the set of utilized potentially insecure data access controls can include access controls utilized in the digital application which potentially impose a security risk, flaw, or other security compromise to a computing device implementing the digital application, a network implementing and/or communicating with the digital application, or a user of the digital application (e.g., deprecated application permissions and/or dangerous or compromised application permissions). In some instances, the set of utilized potentially insecure data access controls can also include purpose type descriptors and/or categorizations for the digital application. Indeed, the application scanning service system 106 can generate a set of utilized potentially insecure data access controls for a digital application as described in greater detail below (e.g., in reference to FIG. 4).

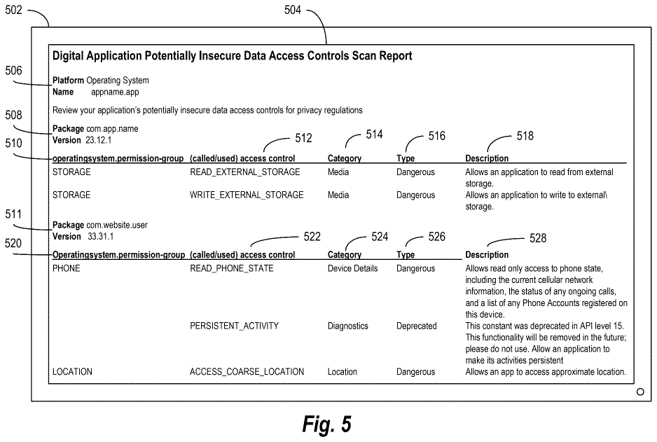

Additionally, as shown in an act 130 of FIG. 1, the application scanning service system 106 triggers a digital action for the digital application based on a set of utilized potentially insecure data access controls (detected from the digital application). Indeed, in one or more instances, the application scanning service system 106 utilizes a set of digital action triggers (or a digital action trigger model) to determine a response (or digital action) for a detected utilized potentially insecure data access control. For instance, as shown in the act 130, the application scanning service system 106 can generate a scan report that efficiently displays detected utilized potentially insecure data access controls and details corresponding to the utilized potentially insecure data access controls. In some instances, the application scanning service system 106 triggers digital actions, such as, but not limited to, electronic notifications for the detected utilized potentially insecure data access controls, system installation determinations for the digital application corresponding to the detected utilized potentially insecure data access controls, compliance detection for the digital application, data compliance automation actions for the digital application, and/or mapping actions to associated the detected utilized potentially insecure data access controls with the digital application in an application scanning platform (or network). Indeed, the application scanning service system 106 can trigger a digital action for the digital application based on a set of utilized potentially insecure data access controls as described in greater detail below (e.g., in reference to FIGS. 5-7).

The disclosed application scanning system provides several advantages over conventional systems. For example, unlike many existing scanning tools that simply list components related to a digital application, the application scanning service system can intelligently scan a digital application to generate valuable and focused insights corresponding to data privacy and security for digital applications. Indeed, the application scanning service system can detect potentially insecure data access controls to generate scan reports (or other digital actions) that enable practical applications for data privacy and security for the digital applications beyond listing of individual components that exist in the application code.

For example, by detecting specific access controls in a digital application that are potentially insecure, the application scanning service system can generate graphical user interfaces that display intelligent, insightful, and actionable scan results for a digital application. For instance, the application scanning service system can scan a digital application and automatically generate graphical user interfaces that display easy to comprehend insights for detected potentially insecure data access controls in a digital application when the digital application includes a large number of components (e.g., thousands or millions of lines of code representing a substantial number of components). Moreover, the application scanning service system can generate intelligent, insightful scan results for a digital application which are practically useable in various applications, such as, scan reports, electronic notifications (e.g., for data consent management), system installation determinations, compliance detection, and/or other application data mapping tasks.

Furthermore, unlike many conventional scanning tools that are difficult (and inefficient) to navigate, the application scanning service system generates graphical user interfaces with application code scan results that easily and quickly enable access to potentially insecure data access controls (or access control categories) within one or more digital applications. In particular, the application scanning service system scans digital applications having a substantial number of processing activity components to single out (or pinpoint) potentially insecure data access controls that pose data privacy and/or security risks to users or system networks interacting with the digital applications. Furthermore, the application scanning service system can display the potentially insecure data access controls and/or categories for the potentially insecure data access controls (and additional information for the potentially insecure data access controls) within a single, viewable user interface. In many cases, the application scanning service system generates such graphical user interfaces to reduce inefficient user navigation between various libraries, a scan result UI, and/or search engines to determine the access controls involved in a digital application and data privacy and/or security risks corresponding to the access controls.

In some cases, the application scanning service system can also enable quick and efficient navigation between detected potentially insecure data access controls across different versions of a digital application. Furthermore, the application scanning service system can also enable quickly and efficiently detected changes in access control data security risks to update scan results (or potentially insecure data access control associations) of a digital application. To illustrate, in many conventional systems, users are unable to determine differences between detected access controls and/or between multiple versions of an application code without manually navigating in between multiple scans of the multiple versions of the application code.

Indeed, the application scanning service system, via the digital application scan, provides a practical application that allows for efficient digital application modifications and/or digital application network management in light of changes in data privacy management and/or data privacy laws. To illustrate, in many cases, application administrators or developers may change (or modify) application code to address frequent updates in data privacy management and/or data privacy law based on the detected potentially insecure data access controls within the digital applications. Oftentimes, in response to such updates, many conventional systems require administrators or developers to identify digital application uses of access controls that relate to the updated data management policies and/or laws through a tedious and time consuming review of the application and available access controls. Unlike such conventional systems, the application scanning service system utilizes the detected potentially insecure data access controls (in accordance with one or more implementations herein) to enable quick modifications of the digital application (e.g., by configuring the access controls utilized in the digital application) that relates to the updated data management policies and/or data laws.

In many cases, the application scanning service system scans digital applications to generate graphical user interfaces with practical applications. For instance, the application scanning service system generates graphical user interfaces with detected potentially insecure data access controls to enable detection of the components existing within (often large) applications for data privacy applications and/or software application audits. Indeed, in some cases, the application scanning service system utilizes the detected potentially insecure data access controls for compliance determinations (e.g., to detect for certain types of access controls within a digital application). For instance, in some instances, a software deployment platform system utilizes outputs and/or user interfaces of the application scanning service system to detect potentially insecure data access controls within an application prior to distributing a software application. This enables the developer to understand what access controls pose data privacy and/or security risk within a software application prior to deploying the software application. This in turn allows the software deployment system to manage consent of users who will access the software application. In some cases, the application scanning service system enables displaying of the detected potentially insecure data access controls within the software deployment platform system user interfaces to enable users to view the potentially insecure data access controls within an application prior to downloading the application.

Additionally, certain aspects of the application scanning service system improve the accuracy of computing systems that manage digital data trackage/usage in accordance with requirements for various data policies. In particular, the application scanning service system utilizes potentially insecure data access controls detected in an application code in connection with any number of data policies and data assets to accurately determine relationships between the data policies and software application use of data. For instance, by detecting potentially insecure data access controls in relation to the data policies, the application scanning service system can automatically detect digital applications that violate a particular data policy. In particular, the application scanning service system leads to faster data access times and reduces the computational load spent searching for access controls relevant to one or more data policies.

As used herein, the term “application” (or “digital application”) refers to a set of instructions (or commands) that execute a software and/or computer program. In particular, a digital application can include can a set of executable instructions that result in one or more data processing activities and/or user interactions with data in a computing device. Furthermore, a digital application can be implemented through application source code. Indeed, application source code can include a set of text (e.g., source code) representing instructions that compile and/or assemble to a machine-readable format that is executable as a digital application. For example, an application code can include software source code, object code, access control instructions, a mobile phone application package (e.g., an Android Package Kit (APK) files, IPA files), and/or markup scripts, such as, but not limited to, C++ code, Java code, Python scripts, JavaScript, HTML, and/or binary assembly code. In some cases, an application code can include a collection of multiple software source code, object code, and/or markup scripts to represent function calls, data, variable SDKs, APIs, and/or other libraries (e.g., access controls) involved in an application.

Furthermore, as used herein, the term “data processing activity component” (or “application component”) refers to a reference, instruction, or object within an application code that causes the performance of one or more actions associated with data. In some cases, the data processing activity component includes a data processing operation including, but not limited to, a computing process or action corresponding to execution of processing instructions to process, collect, access, store, retrieve, modify, or delete target data. In some cases, the data processing activity component includes a data processing operation including, but not limited to, a computing process or action corresponding to interacting with one or more components of a computing device. To illustrate, a data processing activity component can include, but is not limited to, access controls, a software development kit (SDK) component, mobile SDK, application programming interface (API) component, website cookies, website functions, or function call component within an application code (that enables processing, collecting, accessing, storing, retrieving, modifying, or deleting data).

Additionally, as used herein, the term “access control” refers to a component (or feature) within a digital application that regulates (or manages) what the digital application can access and/or utilize on a computing device and/or from user data. For example, an access control can include an application permission that controls (or manages) a digital application's ability to access or utilize particular data and system resources, such as, but not limited to, a computing device camera, microphone, Bluetooth, Wi-Fi, cellular antennas, device data, contacts data, location data, location sensors, storage devices, and/or other computing device sensors. In one or more instances, the digital applications include a declaration of application permissions (e.g., in a manifest file) to enable an operating system to manage access to various computing device resources and/or data for the functions of the digital application. In some implementations, the application scanning service system 106 can identify (or detect) SDK level permissions as access controls (to detection potentially insecure SDK level permissions) in accordance with one or more implementations herein.

Moreover, as used herein, the term “potentially insecure data access control” refers to an access control determined to have a data privacy or data security risk. In particular, a potentially insecure data access control can include access controls (or application permissions) determined to be instable, dangerous, deprecated, flawed, contain insecure authentication mechanisms, requested but not utilized, and/or compromised such that the access controls pose a data privacy and/or data security risk to a network, a computing device, and/or to a user of a digital application.

Additionally, as used herein, the term “digital action” refers to an execution of a digital task (or instruction) to generate and/or implement one or more reactions detected results from a digital application scan. For example, a digital action includes one or more executed tasks resulting from detecting a potentially insecure data access control within a digital application. For example, a digital action can include generating a scan report, displaying a scan report, transmitting an electronic notification, executing a system installation determination, analyzing or detecting compliance data for a digital application, and/or generating mappings for application data.

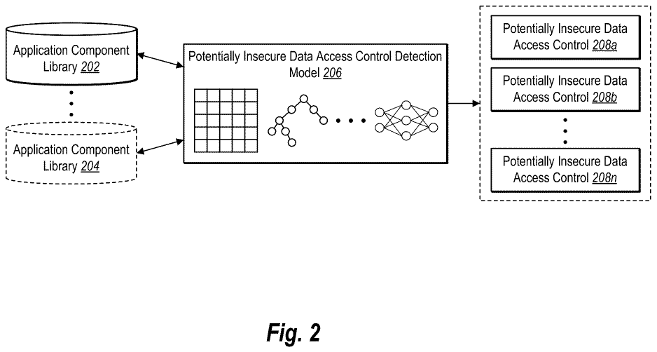

As mentioned above, the application scanning service system 106 can identify potentially insecure data access controls from a library of access controls. For instance, FIG. 2 illustrates the application scanning service system 106 utilizing a potentially insecure data access control detection model to detect (or determine) potentially insecure data access controls from one or more application component libraries that include access control data. As shown in FIG. 2, the application scanning service system 106 identifies one or more application component libraries (e.g., application component library 202, application component library 204). In addition, as shown in FIG. 2, the application scanning service system 106 access (or extracts) data from the one or more application component libraries to utilize a potentially insecure data access control detection model 206 to identify potentially insecure data access controls from the one or more application component libraries. Indeed, as shown in FIG. 2, the application scanning service system 106 utilizes the potentially insecure data access control detection model 206 to identify and generate a set (or list) of potentially insecure data access controls (e.g., potentially insecure data access controls 208a-208n).

For instance, the application scanning service system 106 utilize one or more application component libraries. Indeed, an application component library can include one or more data processing components available to one or more digital applications (e.g., to build the functions or data for the digital applications). For example, an application component library can include data types, method calls, function package libraries, definitions for syntax and/or target functions, and/or access control components. As an example, the application component library can include a data repository for coding references, an application programming interface (API) library, and/or developer programming reference pages (e.g., XML files). In one or more instances, the application component library can include web data and/or a database of application component data.

In some cases, the application scanning service system 106 can utilize an operating system manifest library as the application component library (e.g., from an operating system implementing the digital application). For example, the application scanning service system 106 can utilize an operating system manifest library that references a set of data types (e.g., strings, constants, code identifiers, keys) for different types of access controls (or access control permissions) that a digital application can request from a user, an operating system, and/or a client device. Indeed, in one or more cases, the operating system manifest library defines the actions or access that a digital application requires to function. For instance, the type of actions or access controls included in an operating system manifest library include actions or accesses, such as, but not limited to accessing the camera, location, internal storage, external storage, sensors, sensitive data, and/or network components of an operating system and/or a client device. In addition, the application scanning service system 106 can identify information, from an operating system manifest library, that indicates data sensitivity for particular actions or access types (e.g., to determine security risks of access controls) and/or version data for the particular actions or access types (e.g., to determine security risks of access controls via deprecation). For example, the application scanning service system 106 can utilize, as an operating system manifest library a mobile device operating system API collection (or manifest) to identify data for various access controls available to digital applications operating (or implemented) on a mobile device operating system.

In some cases, the application scanning service system 106 can utilize, as an application component library, a detector specification that includes mappings between one or more data processing activity component identifiers and descriptive data for the data processing activity component identifiers. Indeed, the detector specification can include mappings between one or more access controls (as data processing activity component identifiers) and descriptive data for the access controls. As an example, the application scanning service system 106 can utilize a detector specification as described in SCANNING APPLICATION CODE TO DETECT AND CLASSIFY SDK DATA INTO DATA CATEGORIES, U.S. patent application Ser. No. 18/490,344, filed Oct. 19, 2023 (hereinafter “Application 18/490,344”), which is incorporated herein by reference in its entirety.

In one or more implementations, the application scanning service system 106 utilizes a potentially insecure data access control detection model to generate a set of potentially insecure data access controls from one or more application component libraries (as described above). For example, in one or more instances, the application scanning service system 106 utilizes a potentially insecure data access control detection model that utilizes one or more recognition approaches to identify potentially insecure data access controls from access control data within the one or more application component libraries (e.g., as libraries of access controls).

In some cases, the application scanning service system 106 can utilize the potentially insecure data access control detection model to parse (or scrape) one or more application component libraries. As an example, the application scanning service system 106 can parse data from a website (e.g., using structured data formats, such as, but not limited to HTML, JSON, XML and/or electronic documents, such as, but not limited to, text documents or PDFs) to extract data corresponding to one or more access controls. In some instances, the application scanning service system 106 can utilize API requests with the one or more application component libraries to request, pull, and/or receive data corresponding to one or more access controls from the one or more application component libraries.

Furthermore, the application scanning service system 106 can utilize the potentially insecure data access control detection model to determine (or detect) potentially insecure data access controls from parsed (or received) access control data from the one or more application component libraries. Indeed, the application scanning service system 106 can utilize a potentially insecure data access control detection model that utilizes a mapping table and/or decision tree recognition to identify one or more labels (or keywords), in the access control data from the one or more application component libraries, that indicate a potentially insecure data access control. For instance, the application scanning service system 106 can detect labels (or keywords), such as, but not limited to, deprecated, dangerous, security risk, flawed, broken, bugged, unverified, untested, and/or unauthorized. Indeed, the application scanning service system 106 can identify one or more access controls from the parsed access control data (from the one or more application component libraries) that are associated with (or correspond to) one or more of the above-mentioned labels (or keywords) to indicate access controls as potentially insecure data access controls.

In some cases, the application scanning service system 106 can utilize a machine learning model to recognize (or predict) potentially insecure data access controls from parsed (or received) access control data from the one or more application component libraries. In particular, the application scanning service system 106 can utilize machine learning to analyze access control data and descriptors (parsed or received from one or more application component libraries) and output predicted labels for the access control data (e.g., as potentially insecure and/or a type of potential insecurity corresponding to particular access control data). For example, the application scanning service system 106 can utilize a variety of machine learning models to recognize (or predict) potentially insecure data access controls from parsed (or received) access control data from the one or more application component libraries, such as, but not limited to, large language models, convolutional neural networks, word embedding models, recurrent neural networks, and/or long short-term memory (LSTM) networks.

Moreover, the application scanning service system 106 can generate a set (or list) of reference potentially insecure data access controls (to utilize in scanning for potentially insecure data access controls in digital applications). In particular, the application scanning service system 106 can identify one or more potentially insecure data access controls (and corresponding data) from the one or more application component libraries (as described above). Moreover, the application scanning service system 106 can generate a list of the identified potentially insecure data access controls with purpose type descriptors that indicate a type of insecurity, such as, but not limited to, deprecated, bugged, security compromised (dangerous), and/or unverified. In some cases, the application scanning service system 106 can also extract a description, from the one or more application component libraries, of the functionality of particular access controls for the set (or list) of reference potentially insecure data access controls. Moreover, the application scanning service system 106 can also determine a data type utilized (or controlled) by a particular access control for the set (or list) of reference potentially insecure data access controls.

In some cases, the application scanning service system 106 generates a set of JSON objects for the potentially insecure data access controls to store the potentially insecure data access controls and data for the potentially insecure data access controls (e.g., purpose type descriptors, descriptions, flags, statuses, versions) within the JSON object structures. In one or more instances, the application scanning service system 106 utilizes JSON object structures to enable utilization of the set of potentially insecure data access controls (as individual JSON objects) within one or more additional systems or platforms. In some cases, the application scanning service system 106 can utilize the JSON object-based set of potentially insecure data access controls as input into one or more machine learning applications (e.g., for digital actions and/or scan reports in accordance with one or more implementations herein).

In one or more instances, the application scanning service system 106 can categorize potentially insecure data access controls to generate potentially insecure data access control categories. For example, the application scanning service system 106 can categorize the potentially insecure data access controls based on data types (e.g., media, location, device details, diagnostics, user data, health data, biometrics data, credit card data, system data, operating system data) corresponding to the potentially insecure data access controls and/or permission groups (e.g., permission groups determined from an operating system manifest library for access controls).

Furthermore, the application scanning service system 106 can categorize the potentially insecure data access controls based on a sensitivity of the data type, such as, but not limited to, sensitive data (e.g., user data, biometrics data, credit card data) and/or non-sensitive data (e.g., diagnostics data, operating system version data). In some cases, the application scanning service system 106 can categorize the potentially insecure data access controls based on a permission type (e.g., accounts, calls, device information access, device hardware access, location access, network access, media access, operating system modifications, notifications access, widgets access) associated with the potentially insecure data access controls. Indeed, the application scanning service system 106 can categorize the potentially insecure data access controls utilizing various combinations of the above-mentioned data types, data type sensitivities, and/or permission types.

In one or more instances, the application scanning service system 106 communicates with (or parses) multiple application component libraries that each include access controls available to digital applications on one or more operating systems to generate a set (or list) of potentially insecure data access controls (as described above). In addition, the application scanning service system 106 can communicate with (or parse) the application component libraries periodically (or in real-time) to identify updates to actions or accesses available for utilization on digital applications through one or/more operating systems and/or a client devices (to add and/or remove potentially insecure data access controls, add, remove, and/or update descriptors or purpose types associated with the potentially insecure data access controls, and/or update potentially insecure data access control categories (in accordance with one or more embodiments herein).

As mentioned above, the application scanning service system 106 can detect potentially insecure data access controls utilized within a digital application. For instance, FIG. 3 illustrates the application scanning service system 106 detecting, from a digital application, one or more potentially insecure data access controls. Indeed, FIG. 3 illustrates the application scanning service system 106 detecting utilized potentially insecure data access controls from a digital application based on a set (or list) of potentially insecure data access controls identified from one or more access control libraries (as described above).

As shown in FIG. 3, the application scanning service system 106 scans a digital application 302 to identify utilized access controls 304. In addition, the application scanning service system 106 utilizes a potentially insecure data access control scanning model 308 to identify one or more utilized potentially insecure data access controls from the digital application 302 based on potentially insecure data access controls 306 (e.g., determined from one or more application component libraries in accordance with one or more implementations herein). For example, the application scanning service system 106 can compare the utilized access controls 304 (from the digital application 302) to the potentially insecure data access controls 306 to identify matching access controls. Indeed, as shown in FIG. 3, the application scanning service system 106 generates a set of utilized potentially insecure data access controls 310 (for the digital application 302) using a comparison between the utilized access controls 304 (from the digital application 302) to the potentially insecure data access controls 306 (using the potentially insecure data access control scanning model 308).

In one or more instances, the application scanning service system 106 detects one or more access controls utilized by a digital application. In particular, the application scanning service system 106 can detect one or more access controls utilized by the digital application by analyzing (or parsing) data corresponding to the digital application (utilizing a potentially insecure data access control scanning model). For example, the application scanning service system 106 can analyze (or parse) metadata corresponding to the digital application to identify one or more access controls indicated in (or utilized by) the digital application. For example, the application scanning service system 106 can detect, as metadata, a declaration file (or data structure) of the digital application (e.g., an XML file, a code file) that includes one or more of the access controls utilized by the digital application. Indeed, the application scanning service system 106 can extract or detect the one or more access controls utilized by the digital application from the metadata (or declaration file) corresponding to the digital application.

In some cases, the application scanning service system 106 utilizes code scanning to scan the source code (or decompiled code) of the digital application to identify one or more access controls utilized by the digital application. Indeed, the application scanning service system 106 can identify one or more target methods and/or other data processing activity components (e.g., SDKs, targets, method calls) corresponding to the digital application code. Indeed, the application scanning service system 106 can utilize a detector specification and/or mappings between the data processing activity components (or target methods) and one or more access controls to detect the one or more utilized access controls within the digital application. For instance, the application scanning service system 106 can scan code of the digital application and/or utilize a detector specification as described in application Ser. No. 18/490,344 and SCANNING APPLICATION CODE TO DETECT AND CLASSIFY SDK DATA UTILIZING A TYPE-BASED ANALYSIS, U.S. patent application Ser. No. 18/632,903, filed Apr. 11, 2024 (hereinafter “Application 18/632,903”), which is incorporated herein by reference in its entirety. Indeed, the application scanning service system 106 can utilize the scanned code and/or detector specification to determine access controls utilized in a digital application (e.g., via mappings between data processing activity components and one or more access controls).

In some instances, the application scanning service system 106 can utilize pattern matching models (as the potentially insecure data access control scanning model) to determine matches between metadata descriptors for access controls and/or data processing components within a digital application and one or more access controls identified from the application component libraries (as described above). For example, the application scanning service system 106 can identify access controls (from existing access controls in one or more application component libraries) that are similar to (or match) the one or more metadata descriptors for access controls and/or data processing components within a digital application to determine utilized access controls for the digital application.

Furthermore, as mentioned above, the application scanning service system 106 can utilize the potentially insecure data access control scanning model to detect (or determine) one or more potentially insecure data access controls from the utilized access controls determined from the digital application. For instance, the application scanning service system 106 can utilize the potentially insecure data access control scanning model to compare the utilized access controls to a set of potentially insecure data access controls (determined or identified in accordance with one or more implementations herein). In some cases, the application scanning service system 106 references the set of potentially insecure data access controls to identify matches between the potentially insecure data access controls and the access controls utilized in the digital application. In one or more instances, the application scanning service system 106 determines one-to-one matches between the set of potentially insecure data access controls and the access controls utilized in the digital application to determine utilized potentially insecure data access controls in the digital application.

In some cases, the application scanning service system 106 can utilize the potentially insecure data access control scanning model to analyze, via machine learning, the set of potentially insecure data access controls and the access controls utilized by the digital application to predict predicted matches (to identify one or more utilized access controls as potentially insecure data access controls). Indeed, the application scanning service system 106 can utilize a variety of machine learning models to predict matches between the set of potentially insecure data access controls and the access controls utilized by the digital application, such as, but not limited to, large language models, convolutional neural networks, word embedding models, recurrent neural networks, and/or long short-term memory (LSTM) networks. Indeed, in some implementations, the application scanning service system 106 determines a prediction confidence score for matches between the set of potentially insecure data access controls and the access controls utilized by the digital application and selects a subset of potentially insecure data access controls as utilized potentially insecure data access controls for the digital application (based on the confidence score satisfying a confidence threshold).

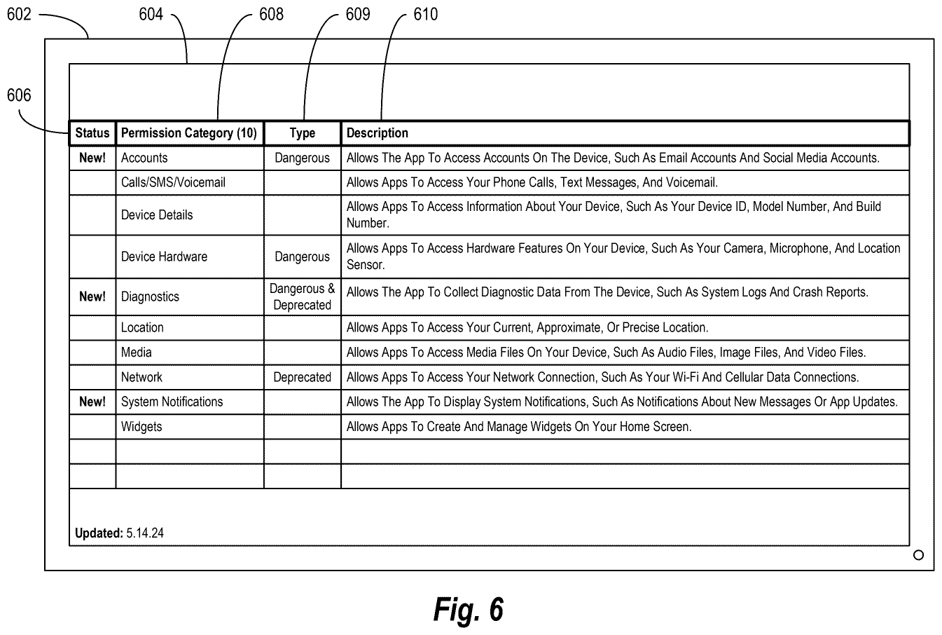

Moreover, the application scanning service system 106 can generate a set of utilized potentially insecure data access controls for the digital application (utilizing detection and matching of access controls to potentially insecure data access controls as described above). In some instances, the application scanning service system 106 can generate the set of utilized potentially insecure data access controls to include purpose type descriptors that indicate (or describe) the type of insecurity, such as, but not limited to, deprecated, bugged, security compromised (dangerous), and/or unverified. In addition, the application scanning service system 106 can also generate the set of utilized potentially insecure data access controls to include descriptors for the functionality of the particular access controls (e.g., as shown in FIGS. 5 and 6).

In one or more implementations, the application scanning service system 106 can identify that a data access control in the digital application is requested and not utilized by the digital application. Moreover, the application scanning service system 106 can flag (or tag) the requested but unused data access control as a potentially insecure data access control. Indeed, the application scanning service system 106 can identify a data access control referenced (or requested) in the digital application (in accordance with one or more implementations herein). Furthermore, the application scanning service system 106 can identify one or more detected methods (in accordance with one or more implementations herein) from the digital application. In response to the identified data access control being unused in the one or more detected methods, the application scanning service system 106 can identify that the data access control is requested and unused by the digital application (e.g., as a potentially insecure data access control).

In some instances, the application scanning service system 106 can also categorize the set of utilized potentially insecure data access controls for the digital application (in accordance with one or more implementations herein). In particular, the application scanning service system 106 can generate access control categories for the utilized potentially insecure data access controls to determine access control categories that include a potentially insecure data access control for the digital application. For example, the application scanning service system 106 can categorize the utilized potentially insecure data access controls based on data types, permission groups, data sensitivity, and/or permission types (as described above). Moreover, the application scanning service system 106 can label and/or flag a particular access control category as potentially insecure based on including a utilized potentially insecure data access control.

In addition, the application scanning service system 106 can generate version specific sets of utilized potentially insecure data access controls for a digital application. In particular, the application scanning service system 106 can track (or determine) utilized potentially insecure data access controls for different versions of the digital application to identify newly added potentially insecure data access controls, newly removed potentially insecure data access controls, and/or modified potentially insecure data access controls. Indeed, the application scanning service system 106 can determine and provide for display version specific changes to the utilized potentially insecure data access controls for the digital application by scanning and determining utilized potentially insecure data access controls for different versions of the digital application. In some cases, the application scanning service system 106 can display the version specific changes in utilized potentially insecure data access controls within digital application scan reports (or comparison reports between digital application versions).

Moreover, the application scanning service system 106 can also determine updates to potentially insecure data access controls based on a scan or analysis of one or more application component libraries (as described above) and use the updated potentially insecure data access controls to update the set of utilized potentially insecure data access controls for the digital application. In particular, the application scanning service system 106 can compare the updated set of potentially insecure data access controls determined from updates to the one or more application component libraries (as described above) to the list of detected utilized access controls from the digital application to determine if existing utilized access controls are potentially insecure based on the updated set of potentially insecure data access controls. Indeed, in one or more implementations, the application scanning service system 106 can provide, for display within a scan report (or an electronic notification) one or more newly detected potentially insecure data access controls in the digital application due to the updated set of potentially insecure data access controls.

As mentioned above, the application scanning service system 106 triggers a digital action for a digital application based on a set of utilized potentially insecure data access controls detected from the digital application. For instance, FIG. 4 illustrates the application scanning service system 106 triggering one or more digital actions based on detected utilized potentially insecure data access controls in a digital application. In particular, as shown in FIG. 4, the application scanning service system 106 utilizes a set of utilized potentially insecure data access controls 402 (detected from a digital application as described above) with digital action triggers 404 to determine (or execute) one or more digital action(s) 406. Indeed, as shown in FIG. 4, the application scanning service system 106 can trigger digital actions, such as, but not limited to, scan reports 408, generate (or transmit) electronic notifications 410, execute system installation determinations 412, execute compliance detection 414, and/or generate application data mappings 416 utilizing the set of utilized potentially insecure data access controls 402.

In one or more instances, the application scanning service system 106 utilizes digital action triggers to determine a digital action response for one or more detected, utilized potentially insecure data access controls in a digital application. For example, the application scanning service system 106 can utilize digital action triggers from a rule-based mapping of conditional triggers for particular utilized potentially insecure data access controls detected in a digital application, access control categories corresponding to the particular utilized potentially insecure data access controls, data sensitivities related to the particular utilized potentially insecure data access controls, and/or other characteristics (or attributes) of the particular utilized potentially insecure data access controls. In particular, the application scanning service system 106 can utilize a rule-based mapping of conditional digital action triggers that determine that one or more detected utilized potentially insecure data access controls meet (or satisfy) one or more conditions from the rule-based mapping of conditional digital action triggers. Subsequently, the application scanning service system 106 can execute a digital action corresponding to the satisfied one or more conditions. In some cases, the application scanning service system 106 can utilize a variety of digital action trigger models, such as, but not limited to a machine learning-based model (to predict digital actions to execute based on detected utilized potentially insecure data access controls and/or a decision tree model (to determine digital actions to execute based on detected utilized potentially insecure data access controls).

For example, as shown in FIG. 4, the application scanning service system 106 can generate (and/or display) one or more scan reports 408 as a digital action in response to one or more utilized potentially insecure data access controls detected in a digital application. In particular, the application scanning service system 106 can generate scan reports for the digital application that indicate the one or more utilized potentially insecure data access controls and/or data for the one or more utilized potentially insecure data access controls. In some instances, the application scanning service system 106 can also utilize versioning data to display changes in the one or more utilized potentially insecure data access controls for the digital application. Moreover, the application scanning service system 106 can also determine access control categories to generate (or display) scan reports with access control category data for the one or more utilized potentially insecure data access controls. Indeed, the application scanning service system 106 can generate scan reports as described in greater detail below (e.g., in reference to FIGS. 5 and 6).

Furthermore, as shown in FIG. 4, the application scanning service system 106 can generate (and/or display) one or more electronic notifications 410 as a digital action in response to one or more utilized potentially insecure data access controls detected in a digital application. As an example, the application scanning service system 106 can generate (or cause the display of) an electronic notification on a client device implementing or executing the digital notification to indicate one or more of the utilized potentially insecure data access controls detected in the digital application.

Additionally, in one or more instances, the application scanning service system 106 can generate (or cause the display of) an electronic notification (or other graphical user element or electronic communication) with selectable options (e.g., selectable access control grant options) to enable or reject one or more of the utilized potentially insecure data access controls detected in the digital application (within the client device). Indeed, the application scanning service system 106 (via the client device) can receive user interactions with the selectable access control grant options and setup the digital application on the client device based on the user interactions. For instance, the application scanning service system 106 can enable the potentially insecure data access controls accepted (or enabled) utilizing user interactions with the selectable access control grant options on the client device (e.g., interacting with an option to enable a particular potentially insecure data access control). In addition, the application scanning service system 106 can reject (or deny) the potentially insecure data access controls rejected (or denied) utilizing user interactions with the selectable access control grant options on the client device (e.g., interacting with an option to reject a particular potentially insecure data access control).

In some cases, the application scanning service system 106 can generate (or cause the display of) an electronic notification (or other graphical user element or electronic communication) in an administrator device of a network corresponding to a client device implementing the digital application. For example, the application scanning service system 106 can generate (or cause the display of) an electronic notification to indicate the utilization or installation, within a client device on the network, of a digital application detected to have one or more potentially insecure data access controls. In some cases, the application scanning service system 106 can also generate (or cause the display of) an electronic notification (or other graphical user element or electronic communication) with selectable options (e.g., selectable access control grant options) to enable or reject one or more of the utilized potentially insecure data access controls detected in the digital application (within the client device) as described above. In addition, the application scanning service system 106 can generate (or cause the display of) an electronic notification (or other graphical user element or electronic communication) with selectable options to deny (or reject) the installation or operation of the digital application on the client device. Indeed, the application scanning service system 106 can provide electronic notifications based on potentially insecure data access controls detected on digital applications for multiple client devices (in accordance with one or more implementations herein).

As further shown in FIG. 4, the application scanning service system 106 can execute and/or implement system installation determinations as a digital action in response to one or more utilized potentially insecure data access controls detected in a digital application. For instance, the application scanning service system 106 can identify that a client device on a particular network (implementing the application scanning service system 106) is installing or executing a digital application having one or more potentially insecure data access controls. In response, the application scanning service system 106 can block installation of the digital application and/or prevent the execution of the digital application on the client device operating in the network. Indeed, the application scanning service system 106 can block or prohibit a digital application within multiple client devices for a particular network (e.g., an enterprise or organizational network with enterprise or organizational computing devices, a facility network, and/or a particular operating ecosystem for computing devices).

In some instances, the application scanning service system 106 can also flag digital applications with particular potentially insecure data access controls within an application store platform (e.g., platforms that deploy applications to various users) to indicate the potential security risk prior to downloading and/or installing a digital application. For instance, the application scanning service system 106 can cause the application store platform to display a list of detected potentially insecure data access controls in relation to a digital application. Indeed, although one or more embodiments describe displaying or flagging potentially insecure data access controls for a single digital application, the application scanning service system 106 can determine and flag (or take other digital actions) for multiple digital applications based on potentially insecure data access controls detected in the digital applications.

Furthermore, as shown in FIG. 4, the application scanning service system 106 can trigger digital actions for compliance detection 414 based on the detected potentially insecure data access controls. For example, the application scanning service system 106 can identify data privacy management and/or data privacy law compliance data. In addition, the application scanning service system 106 can utilize the detected potentially insecure data access controls in the digital applications to determine (or analyze) the digital applications' adherence to the data privacy management and/or data privacy law compliance data. For instance, the application scanning service system 106 can utilize detected potentially insecure data access controls within a digital application to determine (and display) that digital application fails to comply to one or more data privacy management and/or data privacy law compliance requirements.

In addition, the application scanning service system 106 can enable efficient digital application modifications in light of the one or more data privacy management and/or data privacy law compliance requirements. For example, the application scanning service system 106 can enable administrators or developers to change (or modify) digital applications to address frequent updates in data privacy management and/or data privacy law. Indeed, the application scanning service system 106 can utilize detected potentially insecure data access controls and the potentially insecure data access controls relation to data privacy management and/or data privacy law requirements to efficiently pinpoint access controls to modify within the digital application to reflect the updated data management policies and/or data laws.

In some implementations, the application scanning service system 106 generates graphical user interfaces with detected potentially insecure data access controls to enable detection within (often large) digital applications for data privacy applications and/or software application audits. Indeed, the application scanning service system 106 can utilize the detected potentially insecure data access controls for compliance determinations. For instance, a software deployment platform system utilizes outputs and/or user interfaces of the application scanning service system 106 (e.g., the detected potentially insecure data access controls) to detect security or privacy risks within a digital application prior to distributing a software application. This enables a developer or software deployment platform system to understand (or recognize) access controls utilized that pose a security risk or a privacy risk (as determined by data privacy management and/or data privacy law requirements) prior to deploying the software application. In addition, the application scanning service system 106 can enable the software deployment system to manage consent of users who will access the software application utilizing the detected potentially insecure data access controls and descriptors for the detected potentially insecure data access controls. In some cases, the application scanning service system 106 enables displaying of the detected potentially insecure data access controls within the software deployment platform system user interfaces to enable users to view access control insecurities within a digital application prior to downloading the digital application.

As also shown in FIG. 4, the application scanning service system 106 can trigger digital actions for application data mapping 416 based on the detected potentially insecure data access controls. For instance, the application scanning service system 106 can detect potentially insecure data access controls within a digital application and map the potentially insecure data access controls to a data mapping for the digital application. For instance, the application scanning service system 106 can associate the potentially insecure data access control to the digital application in a data mapping available to one or more components of an online data management platform that includes various digital tools for privacy management, data discovery, consent management, and/or artificial intelligent data standards. Indeed, the application scanning service system 106 can enable the various digital tools for privacy management, data discovery, consent management, and/or artificial intelligent data standards (or governance) to access the digital application data mapping to enable the tools to utilize or execute actions based on the associations between digital applications and the detected potentially insecure data access controls.

In some cases, the application scanning service system 106 can map detected potentially insecure data access controls to one or more method calls (or other data processing activity components) identified within a digital application. For instance, the application scanning service system 106 can generate relationships between one or more method calls (or other data processing activity components) identified within a digital application and the potentially insecure data access controls utilized to execute the particular one or more method calls (or other data processing activity components). In some cases, the application scanning service system 106 can update a detector specification (as described in application Ser. No. 18/490,344) utilizing the potentially insecure data access control mappings to particular method calls (or other data processing activity components).

Moreover, in some implementations, the application scanning service system 106 can generate a database utilizing the data mappings for digital applications and detected potentially insecure data access controls. For example, the application scanning service system 106 can generate a knowledge database indicating various digital applications and potentially insecure data access controls corresponding to the digital applications. Indeed, the application scanning service system 106 can enable one or more platforms (or systems) to access the knowledge database to determine security and/or privacy risks for one or more digital applications.

In some instances, the application scanning service system 106 can utilize detected potentially insecure data access controls within a web scan. For instance, the application scanning service system 106 can utilize web scan results to identify digital applications interacting with (or associated with) a scanned website and associate the one or more detected potentially insecure data access controls of the digital applications with the web scan. In some cases, the application scanning service system 106 can also scan a website (in accordance with one or more implementations herein). For example, the application scanning service system 106 can scan a website to identify one or more access control components from the website (or web application) and utilize the set (or list) of insecure data access controls to detect one or more potentially insecure data access controls utilized by the website (or web application) in accordance with one or more implementations herein.

In addition, in some implementations, the application scanning service system 106 also utilizes the detected potentially insecure data access controls for one or more data discovery tasks. For instance, the application scanning service system 106 can utilize digital application data mappings that include potentially insecure data access controls to identify, from data assets (e.g., enterprise software and/or data storage), one or more classified (or tagged) data that are related to (or subject to) the potentially insecure data access controls. In some cases, the application scanning service system 106 can identify, from data assets of a network and/or enterprise software, utilizing a particular digital application (having one or more detected potentially insecure data access controls), one or more tagged data affected by the detected potentially insecure data access controls.

As mentioned above, the application scanning service system 106 can generate scan reports (as triggered digital actions) to efficiently display one or more potentially insecure data access controls utilized in a digital application. For instance, the application scanning service system 106 can generate scan reports that reduce data sprawl and efficiently pinpoint insightful and relevant data related to potentially insecure data access controls utilized in a digital application from an application scan. For instance, FIGS. 5 and 6 illustrate the application scanning service system 106 generating and displaying application scan reports for digital applications based on one or more detected potentially insecure data access controls utilized in the digital applications.

For example, as shown in FIG. 5, the application scanning service system 106 provides, for display within a graphical user interface 504 of a client device 502, a digital application scan report for one or more detected potentially insecure data access controls within a digital application. In particular, as shown in FIG. 5, the application scanning service system 106 generates and displays, within the graphical user interface 504, the digital application scan report to indicate digital application identifiers 506 (e.g., a digital application name and operating system platform) detected from a digital application scan.

Furthermore, as shown in FIG. 5, the application scanning service system 106 can display, within the graphical user interface 504, metadata 508 identified for a package from the digital application (e.g., a package name, a package version) from the digital application scan. In addition, as shown in FIG. 5, the application scanning service system 106 displays utilized potentially insecure data access controls detected for the digital application in relation to the identified package from the digital application. Indeed, as shown in FIG. 5, the application scanning service system 106 displays an application access control group 510 (e.g., an application permission grouping or category type), the access control type 512, a data category 514 for the access control, a purpose type descriptor 516 indicating the type of potentially insecurity, and a description 518 for the potentially insecure data access control. For instance, as shown in FIG. 5, the application scanning service system 106, from a digital application scan and for a particular package type (from metadata 508), identifies and displays access controls (e.g., read_external_storage and write_external_storage for the access control category of storage) as potentially insecure data access controls (e.g., with a purpose type descriptor 516 of dangerous).

Furthermore, as shown in FIG. 5, the application scanning service system 106 can display, within the graphical user interface 504, metadata 511 identified for an additional package from the digital application (e.g., a package name, package version) from the digital application scan. Furthermore, as shown in FIG. 5, the application scanning service system 106 displays utilized potentially insecure data access controls detected for the digital application in relation to the additionally identified package from the digital application. For example, as shown in FIG. 5, the application scanning service system 106 displays an application access control group 520 (e.g., one or more application permission grouping or category types), the access control type 522, a data category 524 for the access control, a purpose type descriptor 526 indicating the type of potentially insecurity, and a description 528 for the potentially insecure data access control. For instance, as shown in FIG. 5, the application scanning service system 106, from a digital application scan and for the additional package type (from metadata 511), identifies and displays access controls (e.g., read_phone_state and persistent_activity for the access control category of Phone and access_coarse_location for the access control category of Location) as potentially insecure data access controls. As shown in FIG. 5, the application scanning service system 106 displays different purpose type descriptors in the purpose type descriptor 526 to display the potentially insecurity as dangerous or deprecated for the individual access controls.

Although FIG. 5 illustrates the application scanning service system 106 displaying detected potentially insecure data access controls categorized by package types from a digital application, the application scanning service system 106 can display detected potentially insecure data access controls for the entire digital application. In some cases, the application scanning service system 106 can also display a scan report with detected potentially insecure data access controls categorized by digital applications (e.g., multiple digital applications and detected potentially insecure data access controls for each of the digital applications).

In some instances, the application scanning service system 106 generates a scan report to display changes in detected potentially insecure data access controls across different versions of a digital application. For instance, the application scanning service system 106 can display, within the scan report, indications of added potentially insecure data access controls and/or removed potentially insecure data access controls within a digital application (e.g., via visual strikethroughs, color highlighting, bolding the added or removed potentially insecure data access controls).

Additionally, the application scanning service system 106 can generate a scan report to display changes to detected access controls for a digital application. For example, the application scanning service system 106 can determine, from an update to the access control data, changes of access controls to insecure data access controls. Moreover, the application scanning service system 106 can utilize the changes to a status of the access control to indicate an updated access control insecurity within a graphical user interface of a scan report (e.g., indicating a change in data and/or privacy security for a particular access control). Indeed, the application scanning service system 106 can display an indicator to indicate that an existing access control is currently insecure and/or that a previously insecure data access control is no longer insecure.

In some implementations, the application scanning service system 106 can generate a scan report to display data processing activity components (e.g., method calls, API calls) related to the one or more of the potentially insecure data access controls. For instance, the application scanning service system 106 can display one or more selectable options for an insecure data access control to navigate to (or cause the display of) a graphical user interface indicating one or more data processing activity components related to (or requiring) the insecure data access control.

Moreover, in one or more embodiments, the application scanning service system 106 determines access control (or data type) categories for the potentially insecure data access controls. In addition, the application scanning service system 106 displays an indication of access control category associated with detected insecure data access controls and/or a data type associated with the detected access controls. In some cases, the application scanning service system 106 enables user interactions to search the graphical user interface for particular access control groups and/or data type associations and/or to sort scan results for the digital application in relation to the detected potentially insecure data access controls.

Additionally, the application scanning service system 106 can generate (and/or display) a purpose type descriptor and/or description for a potentially insecure data access control. For example, the application scanning service system 106 can utilize data extracted from one or more application component libraries (as described above) to determine a purpose type descriptor for the potentially insecure data access control. For example, the purpose type descriptor can include a type indicator that describes why the access control is potentially insecure, such as, but not limited to, dangerous, deprecated, unstable, not reviewed, and/or privacy data sensitive. Moreover, the application scanning service system 106 can generate a description to describe a function of the access control. In some instances, the application scanning service system 106 can parse (or scrape) the description for the access control from an application component library. In one or more embodiments, the application scanning service system 106 can utilize machine learning (e.g., an LLM model, a natural language processing model) to generate the purpose type descriptor and/or access control description from access control data extracted from the one or more application component library.

Furthermore, FIG. 6 illustrates the application scanning service system 106 displaying one or more access control categories (e.g., of one or more access controls that share a similar purpose or functionality) with indications for detected potentially insecure data access controls. For instance, as shown in FIG. 6, the application scanning service system 106 provides, for display within a graphical user interface 604 of a client device 602, a digital application scan report that displays one or more detected potentially insecure data access controls (utilized in a digital application) in relation to access control categories (determined as described above).

In particular, as shown in FIG. 6, the application scanning service system 106 generates and/or displays, within the graphical user interface 604, a digital application scan report that displays an access control category 608 (detected from a digital application). In addition, as shown in FIG. 6, the application scanning service system 106 also displays, in relation to the access control category 608, a status 606, a purpose type indicator 609 for a potential insecurity type, and a description 610. As an example, as shown in FIG. 6, the application scanning service system 106 detects that access controls for an access control category of “Accounts” exists within a digital application and that the “Accounts” access control category newly appeared within the version of the digital application (e.g., as indicated by the status 606). Moreover, as an example, the application scanning service system 106 detects (or determines) that the “Accounts” access control category includes access controls determined as potentially insecure (e.g., dangerous access controls).

As further shown in FIG. 6, the application scanning service system 106 can determine that an access control category detected from the digital application includes multiple types of potentially insecure data access controls (e.g., as shown by the “Diagnostics” access control category). Moreover, as further shown in FIG. 6, the application scanning service system 106 can identify existing access control categories (e.g., “Network”) and indicate potentially insecure data access controls for those access control categories. Indeed, as shown in FIG. 6, the application scanning service system 106 displays the existing access control category of “Network” as having potentially insecure data access controls due to one or more deprecated access controls.

In one or more instances, the application scanning service system 106 detects and displays various combinations of access control categories, status indicators for the access control categories, and various combinations of potentially insecure data access control types for the access control categories (in accordance with one or more implementations herein) to generate and/or display a scan report (as illustrated in FIG. 6).

Moreover, in one or more embodiments, the application scanning service system 106 generates and/or displays selectable options (as graphical user elements) to navigate to (or view) one or more access controls corresponding to an access control category. For instance, the application scanning service system 106 can receive a user interaction with a listed access control category (within graphical user interface displaying a scan report) and, in response, navigate to a graphical user interface displaying one or more access controls detected within a digital application associated with the access control category. In one or more instances, the application scanning service system 106 can also display and/or indicate potentially insecure data access controls associated with the access control category (in response to receive a user interaction with the listed access control category). Indeed, the application scanning service system 106 can generate and/or display a scan report with access controls associated with a particular access control category in accordance with one or more implementations herein.

In some cases, the application scanning service system 106 can also identify one or more access controls that have an undetermined access control category within an “unknown” access control category. Furthermore, in one or more instances, the application scanning service system 106 identifies custom access controls from a digital application and indicates a custom access control category for the custom access controls. In some implementations, the application scanning service system 106 can indicate such access controls and/or the unknown access control category as potentially insecure based on the limited recognition.

In some instances, the application scanning service system 106 can export scan reports (generated as described above). For instance, the application scanning service system 106 can export a generated scan report (generated in accordance with one or more implementations herein) for a variety of systems as exported data, such as, but not limited to, CSV files, PDF files, and/or XML files.

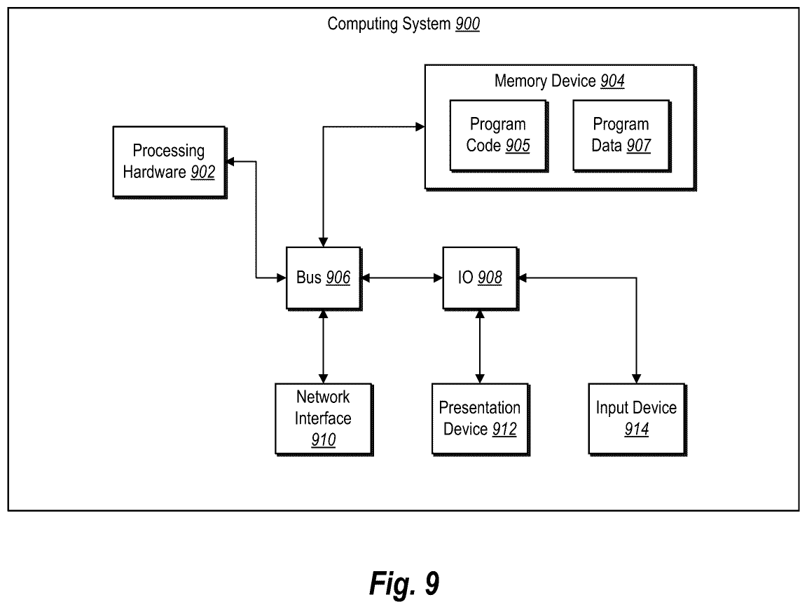

FIG. 7 illustrates a schematic diagram of a system environment 700 in which the application scanning service system 106 can operate in accordance with one or more implementations. Indeed, FIG. 7 depicts an example of the application scanning service system 106 that interacts with a server system 702 and a client computing system 706. In the example environment depicted in FIG. 7, software components in the server system 702 are communicatively coupled with software components in the client computing system 706. In one or more aspects, the server system 702 can operate on a server device(s). Indeed, the server device(s) can include variety of types of computing devices, including those described with reference to FIG. 9.

As shown in FIG. 7, the server system 702 (via a server device) includes the application scanning service system 106. Indeed, the application scanning service system 106 can enable an application scanning service to scan a digital application to detect potentially insecure data access controls and/or trigger actions based on detected potentially insecure data access controls (as described herein).

In one or more aspects, as shown in FIG. 7, the application scanning service system 106 can be implemented (as described herein), in whole or in part, within the server system 702. In some aspects, the application scanning service system 106 can be implemented (as described herein), in whole or in part, within the client computing system 706 (e.g., via a client application 710).

The server system 702 also communicates with one or more application component libraries (as described above). For instance, the application component library 709 can include access control data available to one or more digital applications, access control descriptors, and/or indicators for potentially insecure data access controls (as described above). Indeed, the application scanning service system 106 can determine a set (or list) of potentially insecure data access controls (in accordance with one or more implementations herein) from the application component library 709.

Furthermore, FIG. 7 includes the client computing system 706. In one or more aspects, the client computing system 706 includes a system operated (or implemented) on a computing device (or a network of computing devices). Indeed, the computing device of the client computing system 706 can include a variety of types and number of computing devices, including those described with reference to FIG. 9. In some cases, the client computing system 706 includes a developer computing system, a source code management system, and/or a software deployment platform. In addition, the client computing system 706, via the client application 114, can deploy, modify, display, and/or execute one or more application codes and/or one or more digital applications corresponding to the application codes.

In some cases, the client computing system 706 includes a system operated on a user device operated by a user of an application. In one or more embodiments, the client computing system 706, via the client application 710, can execute an application from input application code in the client repository 712. Furthermore, within the system environment 700, the user device-based client application 710 can communicate with the server system 702 to scan a digital application in accordance with one or more implementations herein.

As shown in FIG. 7, the client computing system 706 includes the client repository 712. In one or more instances, as shown in FIG. 7, the client computing system 706 stores one or more application codes for one or more digital applications within the client repository 712. Indeed, the client repository 712 can include one or more application codes for one or more applications and/or application components (e.g., an SDK, API, code library, access controls).

Indeed, in the example illustrated in FIG. 7, the server system 702, via application scanning service system 106, can execute an application scanning service that can access the application component library 709. The server system 702 can access a digital application, which can be uploaded or otherwise provided to the application scanning service system 106 via the client application 710 executed on the client computing system 706. Moreover, the application scanning service system 106 can scan the digital application and detect one or more potentially insecure data access controls for the digital application as described herein (e.g., in reference to FIGS. 1-6).

In some aspects, a client computing system 706 requests an application scan of a digital application by the application scanning service system 106. For instance, the client computing system 706 can transmit digital application scan request to the application scanning service system 106 (via the server system 702). In addition, in some cases, the client computing system 706 can also indicate (or upload) the digital application to the server system 702 with the scan request. Indeed, the application scanning service system 106 can scan the indicated digital application (from a repository of the digital application (or from an upload of the digital application) (in response to the received scan request) to determine one or more potentially insecure data access controls in the digital application in accordance with one or more implementations herein. In addition, the server system 702, via the application scanning service system 106, can trigger one or more digital actions based on the detected one or more potentially insecure data access controls in the digital application on the client computing system 706 (e.g., via displays, notifications, and/or other features as described in FIGS. 4-6).

Furthermore, in some cases, the client computing system 706 can implement the application scanning service system 106. For instance, the client computing system 706 can receive and deploy the application scanning service system 106 within the client computing system 706. Subsequently, the client computing system 706 can utilize the application scanning service system 106 (in accordance with one or more implementations herein) natively on the client computing system 706.

Moreover, although FIG. 7 illustrates the environment with a single server system 702 and a single client computing system 706, in one or more aspects, the application scanning service system 106 can interact with additional computing systems (or various numbers of computing devices within the computing systems). For example, the application scanning service system 106 can interact with a variety of different numbers of computing systems corresponding to one or more application users and/or administrators (or developers) of applications. Additionally, although FIG. 7 illustrates the application scanning service system 106 interacting with a single client repository 712 and a single application component library 709, the application scanning service system 106 can interact with a variety of different numbers of application component libraries, client repositories, and/or digital application repositories.

Additionally, as shown in FIG. 7, the application scanning service system 106 can utilize a network 708 to enable communication between the server system 702 and the client computing system 706. In some instances, the network 708 can include a suitable network and may communicate using any communication platform and technology suitable for transporting data and/or communication signals, examples of which are described with reference to FIG. 9. Moreover, the various components of the server system 702 and the client computing system 706 can communicate and/or interact via other methods (e.g., the application scanning service system 106 or the server system 702 and the client repository 712 can communicate directly).

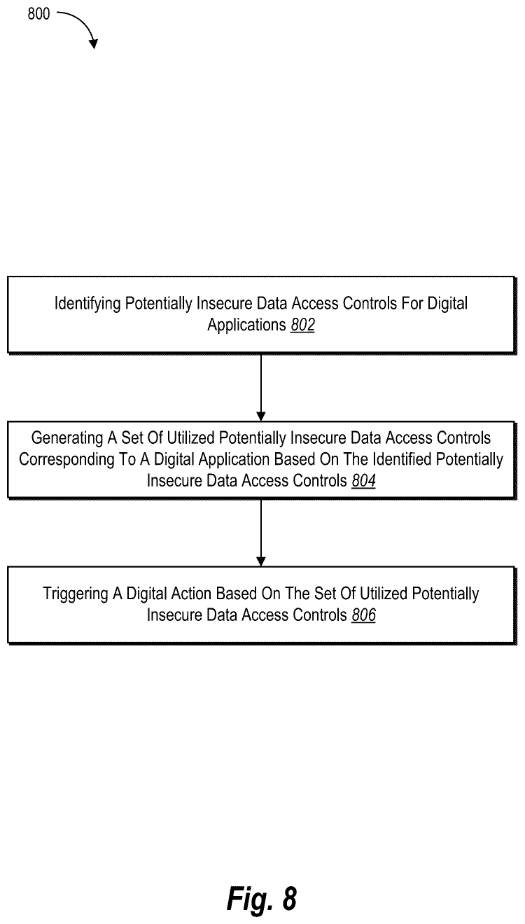

FIGS. 1-7, the corresponding text, and the examples provide a number of different methods, systems, devices, and non-transitory computer-readable media of the application scanning service system 106. In addition to the foregoing, one or more aspects can also be described in terms of flowcharts comprising acts for accomplishing a particular result, as shown in FIG. 8. The acts shown in FIG. 8 may be performed in connection with more or fewer acts. Further, the acts may be performed in differing orders. Additionally, the acts described herein may be repeated or performed in parallel with one another or parallel with different instances of the same or similar acts. A non-transitory computer-readable medium can comprise instructions that, when executed by one or more processors, cause a computing device to perform the acts of FIG. 8. In some aspects, a system can be configured to perform the acts of FIG. 8. Alternatively, the acts of FIG. 8 can be performed as part of a computer implemented method.

For example, FIG. 8 illustrates a flowchart of a series of acts 800 for scanning a digital application to determine potentially insecure data access controls for the digital application in accordance with one or more implementations herein. While FIG. 8 illustrates acts according to one aspect, alternative aspects may omit, add to, reorder, and/or modify any of the acts shown in FIG. 8.

As shown in FIG. 8, the series of acts 800 include an act 802 of identifying potentially insecure data access controls for digital applications, an act 804 of generating a set of utilized potentially insecure data access controls corresponding to a digital application based on the identified potentially insecure data access controls, and an act 806 of triggering a digital action based on the set of utilized potentially insecure data access controls.

In one or more instances, the series of acts 800 can include identifying, by processing hardware, a set of potentially insecure data access controls from a library of access controls available to digital applications, detecting, by the processing hardware, in response to an application scan of a digital application, a set of utilized access controls within the digital application, generating, by the processing hardware, a set of utilized potentially insecure data access controls corresponding to the digital application by comparing the set of utilized access controls to the set of potentially insecure data access controls, and providing, by the processing hardware, for display within a graphical user interface of a client device, the set of utilized potentially insecure data access controls in relation to a scan report for the digital application.

In some cases, the series of acts 800 can include detecting, in response to an application scan of a digital application, a set of utilized access controls within the digital application, generating a set of utilized potentially insecure data access controls corresponding to the digital application by comparing the set of utilized access controls to a set of potentially insecure data access controls from a library of access controls available to digital applications, and, based on the set of utilized potentially insecure data access controls, triggering a digital action within a digital application scanning platform for the digital application.

Moreover, in one or more instances, the series of acts 800 can include parsing a library of access controls available to digital applications to generate a set of potentially insecure data access controls comprising purpose type descriptors, generating a set of utilized potentially insecure data access controls corresponding to a digital application by comparing a set of utilized access controls in a digital application to the set of potentially insecure data access controls, and providing, for display within a graphical user interface of a client device, the set of utilized potentially insecure data access controls and a set of purpose type descriptors corresponding to the set of utilized potentially insecure data access controls.

Furthermore, in some implementations, the series of acts 800 can include parsing, by the processing hardware, a library of access controls available to digital applications to identify the set of potentially insecure data access controls. In one or more instances, the series of acts 800 can include parsing the library of access controls available to the digital applications to generate the set of potentially insecure data access controls by identifying one or more potentially deprecated or potentially compromised access controls within the digital application. In some cases, the series of acts 800 can include comprise generating the set of potentially insecure data access controls by parsing the library of access controls available to digital applications to identify potentially deprecated or potentially compromised access controls.

Moreover, the series of acts 800 can include determining, by the processing hardware, purpose type descriptors for the set of potentially insecure data access controls. In addition, the series of acts 800 can include providing, by the processing hardware, for display within the graphical user interface of the client device, a set of purpose type descriptors corresponding to the set of set of utilized potentially insecure data access controls.

Additionally, the series of acts 800 can include generating, by the processing hardware, the set of utilized potentially insecure data access controls corresponding to the digital application by identifying one or more potentially deprecated or potentially compromised access controls, wherein in the access controls comprise digital application permissions. In some cases, the series of acts 800 can include detecting, in response to the application scan of the digital application, the set of utilized access controls within the digital application as application permissions enabling the digital application to utilize one or more components of a computing device operating the digital application.

Furthermore, in some implementations, the series of acts 800 can include generating, by the processing hardware, an access control category from two or more utilized access controls from the set of utilized access controls. Additionally, the series of acts 800 can include providing, by the processing hardware, for display within the graphical user interface of the client device, the access control category and a corresponding potential insecurity for the access control category based on the set of utilized potentially insecure data access controls.

Moreover, the series of acts 800 can include identifying, by processing hardware, an additional set of potentially insecure data access controls from the library of access controls available to digital applications based on version updates to the library of access controls. Additionally, the series of acts 800 can include generating, by the processing hardware, an additional set of utilized potentially insecure data access controls corresponding to the digital application by comparing the set of utilized access controls to the additional set of potentially insecure data access controls.

Furthermore, in some implementations, the series of acts 800 can include triggering, by the processing hardware, a digital action within a digital application scanning platform for the digital application based on the set of utilized potentially insecure data access controls. Additionally, the series of acts 800 can include triggering, by the processing hardware, the digital action to provide, for display within an additional graphical user interface of an additional client device, a selectable access control grant option to enable or reject a utilized potentially insecure data access control from the set of utilized potentially insecure data access controls within the digital application operated on the additional client device. In addition, the series of acts 800 can include triggering, by the processing hardware, the digital action to block an installation of the digital application corresponding to the set of utilized potentially insecure data access controls within an additional client device communicating with the digital application scanning platform. In some cases, the series of acts 800 can include triggering the digital action to provide, for display within a graphical user interface of a client device, the set of utilized potentially insecure data access controls in relation to a scan report for the digital application.

Implementations of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 depicts an example of a computing system 900 that can be used for performing the operations described herein. One or more devices depicted in FIG. 7 (e.g., a server system 702, a client computing system 706, etc.) can be implemented using the computing system 900 or a suitable variation.

The computing system 900 can include processing hardware 902 that executes program code 905 (e.g., an analysis engine or other component of an application scanning service of the application scanning service system 106). The computing system 900 can also include a memory device 904 that stores one or more sets of program data 907 (e.g., digital applications, access controls, potentially insecure data access controls, etc.) computed or used by operations in the program code 905. The computing system 900 can also include and one or more presentation devices 912 and one or more input devices 914. For illustrative purposes, FIG. 9 depicts a single computing system on which the program code 905 is executed, the program data 907 is stored, and the input devices 914 and presentation device 912 are present. But various applications, datasets, and devices described can be stored or included across different computing systems having devices similar to those depicted in FIG. 9.

The depicted example of a computing system 900 includes processing hardware 902 communicatively coupled to one or more memory devices 904. The processing hardware 902 executes computer-executable program instructions stored in a memory device 904, accesses information stored in the memory device 904, or both. Examples of the processing hardware 902 include a microprocessor, an application-specific integrated circuit (“ASIC”), a field-programmable gate array (“FPGA”), or any other suitable processing device. The processing hardware 902 can include any number of processing devices, including a single processing device.

The memory device 904 includes any suitable non-transitory computer-readable medium for storing data, program instructions, or both. A computer-readable medium can include any electronic, optical, magnetic, or other storage device capable of providing a processor with computer-readable instructions or other program code 905. Non-limiting examples of a computer-readable medium include a magnetic disk, a memory chip, a ROM, a RAM, an ASIC, optical storage, magnetic tape or other magnetic storage, or any other medium from which a processing device can read instructions. The program code 905 may include processor-specific instructions generated by a compiler or an interpreter from code written in any suitable computer-programming language, including, for example, C, C++, C#, Visual Basic, Java, Python, Perl, JavaScript, and ActionScript.

The computing system 900 may also include a number of external or internal devices, such as an input device 914, a presentation device 912, or other input or output devices. For example, the computing system 900 is shown with one or more input/output (“I/O”) interfaces 908. An I/O interface 908 can receive input from input devices or provide output to output devices. One or more buses 906 are also included in the computing system 900. The bus 906 communicatively couples one or more components of a respective one of the computing system 900.

The computing system 900 executes program code 905 that configures the processing hardware 902 to perform one or more of the operations described herein. The program code 905 includes, for example, the one or more applications described herein with respect to FIGS. 1-8 (e.g., the application scanning service, the client application, etc.). The program code 905 may be resident in the memory device 904 or any suitable computer-readable medium and may be executed by the processing hardware 902 or any other suitable processor. The program code 905 uses or generates program data 907.

In some implementations, the computing system 900 also includes a network interface device 910. The network interface device 910 includes any device or group of devices suitable for establishing a wired or wireless data connection to one or more data networks. Non-limiting examples of the network interface device 910 include an Ethernet network adapter, a modem, and/or the like. The computing system 900 can communicate with one or more other computing devices via a data network using the network interface device 910.

A presentation device 912 can include any device or group of devices suitable for providing visual, auditory, or other suitable sensory output. Non-limiting examples of the presentation device 912 include a touchscreen, a monitor, a separate mobile computing device, etc. An input device 914 can include any device or group of devices suitable for receiving visual, auditory, or other suitable input that controls or affects the operations of the processing hardware 902. Non-limiting examples of the input device 914 include a recording device, a touchscreen, a mouse, a keyboard, a microphone, a video camera, a separate mobile computing device, etc.

Although FIG. 9 depicts the input device 914 and the presentation device 912 as being local to the computing device that executes the program code 905, other implementations are possible. For instance, in some implementations, one or more of the input devices 914 and the presentation device 912 can include a remote client-computing device that communicates with the computing system 900 via the network interface device 910 using one or more data networks described herein.

While the present subject matter has been described in detail with respect to specific implementations thereof, it will be appreciated that those skilled in the art, upon attaining an understanding of the foregoing, may readily produce alterations to, variations of, and equivalents to such implementations. Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter. Accordingly, the present disclosure has been presented for purposes of example rather than limitation, and does not preclude the inclusion of such modifications, variations, and/or additions to the present subject matter as would be readily apparent to one of ordinary skill in the art.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

Implementations of the methods disclosed herein may be performed in the operation of such computing devices. The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing some aspects of the present subject matter. Any suitable programming, scripting, or other type of language or combinations of languages may be used to implement the teachings contained herein in software to be used in programming or configuring a computing device. The order of the blocks presented in the examples above can be varied—for example, blocks can be re-ordered, combined, and/or broken into sub-blocks. Certain blocks or processes can be performed in parallel.

What is claimed is:

1. A computer-implemented method comprising:
identifying, by processing hardware, a set of potentially insecure data access controls from a library of access controls available to digital applications;
detecting, by the processing hardware, in response to an application scan of a digital application, a set of utilized access controls within the digital application;
generating, by the processing hardware, a set of utilized potentially insecure data access controls corresponding to the digital application by comparing the set of utilized access controls to the set of potentially insecure data access controls; and
providing, by the processing hardware, for display within a graphical user interface of a client device, the set of utilized potentially insecure data access controls in relation to a scan report for the digital application.

2. The computer-implemented method of claim 1, further comprising parsing, by the processing hardware, a library of access controls available to digital applications to identify the set of potentially insecure data access controls.

3. The computer-implemented method of claim 1, further comprising:
determining, by the processing hardware, purpose type descriptors for the set of potentially insecure data access controls; and
providing, by the processing hardware, for display within the graphical user interface of the client device, a set of purpose type descriptors corresponding to the set of set of utilized potentially insecure data access controls.

4. The computer-implemented method of claim 1, further comprising generating, by the processing hardware, the set of utilized potentially insecure data access controls corresponding to the digital application by identifying one or more potentially deprecated or potentially compromised access controls, wherein in the access controls comprise digital application permissions.

5. The computer-implemented method of claim 1, further comprising:
generating, by the processing hardware, an access control category from two or more utilized access controls from the set of utilized access controls; and
providing, by the processing hardware, for display within the graphical user interface of the client device, the access control category and a corresponding potential insecurity for the access control category based on the set of utilized potentially insecure data access controls.

6. The computer-implemented method of claim 1, further comprising:
identifying, by processing hardware, an additional set of potentially insecure data access controls from the library of access controls available to digital applications based on version updates to the library of access controls; and
generating, by the processing hardware, an additional set of utilized potentially insecure data access controls corresponding to the digital application by comparing the set of utilized access controls to the additional set of potentially insecure data access controls.

7. The computer-implemented method of claim 1, further comprising triggering, by the processing hardware, a digital action within a digital application scanning platform for the digital application based on the set of utilized potentially insecure data access controls.

8. The computer-implemented method of claim 7, further comprising triggering, by the processing hardware, the digital action to provide, for display within an additional graphical user interface of an additional client device, a selectable access control grant option to enable or reject a utilized potentially insecure data access control from the set of utilized potentially insecure data access controls within the digital application operated on the additional client device.

9. The computer-implemented method of claim 7, further comprising triggering, by the processing hardware, the digital action to block an installation of the digital application corresponding to the set of utilized potentially insecure data access controls within an additional client device communicating with the digital application scanning platform.

10. A non-transitory computer-readable medium storing executable instructions which, when executed by a processing device, cause the processing device to perform operations comprising:
detecting, in response to an application scan of a digital application, a set of utilized access controls within the digital application;
generating a set of utilized potentially insecure data access controls corresponding to the digital application by comparing the set of utilized access controls to a set of potentially insecure data access controls from a library of access controls available to digital applications; and
based on the set of utilized potentially insecure data access controls, triggering a digital action within a digital application scanning platform for the digital application.

11. The non-transitory computer-readable medium of claim 10, wherein the operations further comprise generating the set of potentially insecure data access controls by parsing the library of access controls available to digital applications to identify potentially deprecated or potentially compromised access controls.

12. The non-transitory computer-readable medium of claim 10, wherein the operations further comprise detecting, in response to the application scan of the digital application, the set of utilized access controls within the digital application as application permissions enabling the digital application to utilize one or more components of a computing device operating the digital application.

13. The non-transitory computer-readable medium of claim 10, wherein the operations further comprise triggering the digital action to provide, for display within a graphical user interface of a client device, a selectable access control grant option to enable or reject a utilized potentially insecure data access control from the set of utilized potentially insecure data access controls within the digital application operated on the client device.

14. The non-transitory computer-readable medium of claim 10, wherein the operations further comprise triggering the digital action to block an installation of the digital application corresponding to the set of utilized potentially insecure data access controls within a client device communicating with the digital application scanning platform.

15. The non-transitory computer-readable medium of claim 10, wherein the operations further comprise triggering the digital action to provide, for display within a graphical user interface of a client device, the set of utilized potentially insecure data access controls in relation to a scan report for the digital application.

16. A system comprising:
one or more non-transitory computer readable media; and
processing hardware configured to cause the system to:
parse a library of access controls available to digital applications to generate a set of potentially insecure data access controls comprising purpose type descriptors;
generate a set of utilized potentially insecure data access controls corresponding to a digital application by comparing a set of utilized access controls in the digital application to the set of potentially insecure data access controls; and
provide, for display within a graphical user interface of a client device, the set of utilized potentially insecure data access controls and a set of purpose type descriptors corresponding to the set of utilized potentially insecure data access controls.

17. The system of claim 16, wherein the processing hardware is configured to cause the system to detect the set of utilized access controls within the digital application as application permissions enabling the digital application to utilize one or more components of a computing device operating the digital application.

18. The system of claim 16, wherein the processing hardware is configured to cause the system to parse the library of access controls available to the digital applications to generate the set of potentially insecure data access controls by identifying one or more potentially deprecated or potentially compromised access controls within the digital application.

19. The system of claim 16, wherein the processing hardware is configured to:
generate an access control category from two or more utilized access controls from the set of utilized access controls; and
providing, for display within the graphical user interface of the client device, the access control category and a corresponding potential insecurity based on the set of utilized potentially insecure data access controls.

20. The system of claim 16, wherein the processing hardware is configured to trigger a digital action within a digital application scanning platform for the digital application based on the set of utilized potentially insecure data access controls.
